(19) United States
(12) Patent Application Publication
(10) Pub. No.: US 2006/0046233 A1
(43) Pub. Date: Mar. 2, 2006

(54) System and method incorporating actionable targeted feedback

(76) Inventor: William C. Byham, Pittsburgh, PA (US)

Correspondence Address: REED SMITH LLP, P.O. BOX 488, PITTSBURGH, PA, 15230-0488, US

(21) Appl. No.: 11/147,672

(22) Filed: Jun. 7, 2005

Related U.S. Application Data
(60) Provisional application No. 60/577,758, filed on Jun. 7, 2004.

(51) Int. Cl. G09B 19/00

(52) U.S. Cl. 434/236

(57) ABSTRACT

A system and method for evaluating employees and, more particularly to a targeted system and method incorporating actionable feedback. Rather than rating every item and competency in the survey, the respondents and self-evaluators only chose one to three strong competencies and one to three weak competencies. Items beneath those two to six chosen competencies are in turn selected according to their support of the strength or contribution to the weakness, but not according to a rating scale. Respondents are asked to indicate their willingness to support the subject in his/her subsequent endeavors to leverage strengths and improve developmental areas.

### CROSS-REFERENCE TO RELATED APPLICATIONS

This application claims the benefit under 35 U.S.C. 119 (e) of U.S. provisional application Ser. No. 60/577,758, filed on Jun. 7, 2004, the disclosure of which is incorporated by reference herein.

### BACKGROUND OF THE INVENTION

1. Field of the Invention

The present invention generally relates to systems and methods for evaluating employees, and, more particularly to a targeted system and method incorporating actionable feedback to better evaluate and assess employees.

2. Related Art

For many years, organizations have experimented with multirater feedback surveys (sometimes called “360s”) in an effort to better develop and deploy their employees. The practice of collecting and analyzing perceptual data from those working closest to an individual—managers, peers, direct reports, customers, etc.—has gained popularity because it may provide an opportunity for systematic measurement and meaningful feedback to pinpoint an individual's strengths and development opportunities, and to match employees to assignments that fit.

Current multirater surveys have several common features:

1. Subjects: Subjects are evaluated by respondents on a series of items related to a list of competencies.
a) The subject is the person about whom the survey is directed, also called the “target” or “feedback receiver.”
b) The respondents are the persons who provide their perceptions of the subjects, also called “raters.”
c) The items are a set of sub-categories or sub-behaviors from which the results are rolled up into a score for each competency, also referred to as “the major category”. These sub-categories are also called “behaviors,” “key behaviors,” “key actions,” etc.
d) The competencies are the major behavioral categories addressed by the survey, also called “dimensions,” “performance areas,” “result areas,” etc.

2. Anonymity: The respondents' individual evaluations of the subjects are not revealed. However, results may be provided according to groups of respondents with a certain relationship to the subject, such as peers, direct reports, customers, the manager, etc., but only if the group is of sufficient size to protect individual responses. The exception to this is the subject's manager's ratings, which are typically revealed.

3. Self-evaluation: Most multirater surveys also ask the subject to self-evaluate in order to provide comparisons between self-perceptions and those of others surrounding the subject.

4. Rating scales: Respondents (and subject self-raters) are presented with one or more numerical scales from which to select a rating for each item in the survey. A scale is commonly included for gauging the subject's current proficiency, past proficiency, and/or frequency in each performance area. Often, there is also a scale for gauging the importance of the item to success in the current or target job. Typically, these scales have 5 points with text descriptors like “meets expectations,” “moderate level,” “frequently exhibits,” or “very important.” Sometimes the scales have as few as 3 points or as many as 10.

5. Anonymous Comments: Open-ended Feedback-Multirater surveys commonly offer respondents with one or more places they can write anonymous comments.

6. Reports: Rating scale averages are the heart of multirater survey results. Typically, there is a summary of the rolled up averages for each competency area, sorted from strength to weakness, with detailed reports providing average ratings for each scale applied to each item, with ancillary data such as gaps between self-ratings and others or gaps between required and current proficiency. Measures of dispersion (such as response ranges and standard deviations) and comparisons to norms are also common. Finally, all “open-ended feedback” comments are printed. Overall, the amount of numeric and text data is often so detailed that it becomes overwhelming.

A number of perceived problems with traditional multirater systems are as follows:

Report Card Mentality: Respondents and subjects alike often perceive 360° surveys as being like “report cards”. This can create a negative and competitive atmosphere—subjects don't trust results —and respondents' prejudice or lack of candor may skew results.

Rater Fatigue: Traditional multirater feedback surveys can take raters up to an hour to complete for each subject. Raters evaluate each person on one or more multiple-point rating scales for each of up to 100 more items. Raters are known to complain that the task becomes tedious and repetitive, and practitioners theorize that this promotes rater indifference to survey accuracy.

Accuracy: Generally, there is little or no orientation for respondents, creating a wide variance in scoring interpretation (some may be high graders, others low graders). What is more, respondents may score competencies by association: “If Jim is a good delegator, then he must be good at coaching.” Also, it is common for respondents to rate artificially high across all subjects, resulting in little variation in the feedback, and thus eroding the perceived value of the feedback to the subjects.

Confusion: The amount of feedback can create information overload for subjects, masking the most critical development needs. It is often difficult to see patterns in the data, or to discern comparative similarities and differences in the feedback from various respondent groups.

Exacerbating the situation is minimal variation in scores-commonly 0.2 or 0.3 between competencies at best.

Rationalization: When subjects, especially those at executive levels, receive relatively high scores on all the competencies, it is easy for them to rationalize they have no room for improvement. Similarly, some subjects discuss ratings saying things like “being poor in that competency has not held my career back in the past.”

Reinforcement: Traditional approaches mask the manager's feedback and/or under-leverage his or her involvement in the subject's response to the multirater feedback. When management support is not built into the process, there is little hope that development plans will work. Yet, many people are reluctant to ask for help. Similarly, if direct reports are engaged in a leader's development process, there are more chances to succeed, but few subjects ask for their help usually because they are unaware of others' willingness to help.

Accordingly, it is desirable to provide an improved multirater feedback system and method for evaluating employees.

### SUMMARY OF THE INVENTION

The present invention relates to a system and method for evaluating employees, and, more particularly to a targeted system and method that is clear and direct in its feedback, incorporating actionable feedback. The present invention overcomes the shortcomings of prior known systems as discussed below.

Rather than rating every item and competency in the survey, the respondents and self-evaluators only chose one to three strong competencies and one to three weak competencies (also known as development areas or growth areas).

At the option of the survey administrator, respondents may be asked to provide additional insight by choosing from a list of items beneath those two to six chosen competencies, those items that support the strength or contribution to the weakness, but not according to a rating scale. Therefore, respondents do not apply proficiency or importance rating scales to the items and/or competencies.

Also at the option of the survey administrator, respondents may be asked to indicate their willingness to support the subject in his/her subsequent endeavors to leverage strengths and improve developmental areas.

The present invention significantly departs from traditional methods in its reporting of the feedback results to the individual subjects and their organization. Rather than long lists of numerical means, ranges, normative averages, etc., the invention displays a unique matrix displaying at a glance the three most significant strengths and three most significant weaknesses or growth areas, arranged as a series of blocks across rows by competency, and columns by respondent group (peers, subordinates, customers, etc.). This graphic representation ameliorates the complexity and confusion of the traditional statistic-centric approach.

In addition to providing targeted feedback results to the subjects, the present invention provides developmental resources for subjects to use to leverage their strengths and address their developmental needs. These resources are prescriptive to the survey results, and include such embedded resources as development guides, reading lists, skill-building courses, suggested targeted activities, and electronic links to other related content.

The present invention provides advantages over the known prior art systems as discussed below:

The present invention provides increased focus and clarity over known prior art systems by providing a breakthrough alternative multirater approach designed to accelerate behavioral change and to overcome some of the common barriers to traditional 360° implementations. “Targeted” means targeted toward focused development—it uniquely shifts the focus from employee evaluations and ratings on all competencies in a survey to actionable development on a select few. The targeted feedback of the present invention energizes individual development by stripping away the misperceptions, misunderstandings, and negativity associated with many multirater processes to reveal an individual's principal strengths and development needs. Subjects come away with clearer direction and an understanding that people are willing to help them effectively change specific behavior in a positive way. Thus, organizations receive a greater return on investment (ROI) in the form of measurable development results.

The present invention further provides a less threatening approach. Traditional multirater results are replete with numbers and therefore create “a report card” impression. Removing rating points from the process eliminates the report card mentality, and shifts the focus to the subject's three most critical development needs and strengths.

The present invention also provides a more natural approach. The thought process is more natural for respondents. When thinking about others, it is common for people to quickly think of a few strengths and weaknesses or growth areas. Few people conduct an exhaustive mental inventory of a person's strengths and weaknesses across a full model of competencies. The present invention is designed to be more reflective of how people think when considering the job-related performance of others. It also allows respondents to focus on competencies they are familiar with versus “guessing” in areas that may be outside of the context of their relationship to the subject. Respondents only provide feedback on those competencies that they are familiar with and feel are most important. They do not feel forced to rate areas where they have little or no knowledge. This narrowing of the focus to a maximum of three competency strengths and three areas for development simplifies the process, resulting in more accurate ratings, less rater fatigue, and greater emphasis on development.

The present invention provides less respondent fatigue. In a traditional multirater survey with, say, 6 items under each of 15 competencies, rated on a dual scale (importance and proficiency), each respondent must make 180 decision entries (15×6×2). In the present invention, regardless of the number of competencies, only a maximum of 6 are focused upon. Early testing suggests the surveys of the present invention may be 25% to 50% less tedious and time-consuming for respondents and self-evaluators.

The present invention is simpler to interpret. Subjects receiving traditional multirater instruments are often confused by the large number of competencies about which they receive feedback and the apparently small differences among the competency ratings. Detailed, sometimes conflicting data can shroud intended outcomes and confuse subjects. After receiving their reports, subjects often are left perplexed about required next steps and who will help them in their development plans. In the present invention, feedback reports are simplified, providing subjects with a clearer understanding of strengths and development areas. The first of two reports show simple, non-numerical lists of their top strengths and weaknesses or growth areas. The invention's second report displays the unique matrix that arranges the results into a series of blocks across rows by competency, and columns by respondent group (peers, subordinates, customers, etc.), prioritized by the manager's choices (Note: when the matrix comparison report is viewed in a Web browser, the subject may elect to organize the matrix by a different respondent group's choices). This graphic representation ameliorates the complexity and confusion of the traditional statistic-centric approach. The effect of these simple and unique reports is to make it much easier for subjects and their managers to focus on priorities and create more effective development plans. Setting priorities is much easier, and it enables subjects to create a more effective development plan.

The present invention is actionable. The structure of the present invention's approach effectively diminishes many problems inherent to traditional multirater processes by focusing on actionable feedback, not rating scales. Because respondent feedback is concentrated on a maximum of three competency strengths and three weaknesses, it is less confusing and is more actionable. Because subjects receive reports that are limited to three areas of strength and three areas for development, there is little room to rationalize results. The data from the system of the present invention sends a clear, incontrovertible message to the subject.

The present invention is encouraging. The “Willingness to Support” feature enables respondents to register a willingness to help subjects with their development. It can also accelerate behavior change by creating expectations by respondents for improvement actions on the part of the subjects. The “Willingness to Support” feature leaves little doubt among subjects of the level of support available from the respondents who have provided feedback.

The present invention may be implemented manually utilizing a computer based system having an on-line web-based environment utilizing a suitable database, hardware, software, network or application, including but not limited to intranets, internets, or other web-based environment available on a single computer, a network of computers, or a local server, or an intranet or internet on the world-wide-web.

### BRIEF DESCRIPTION OF THE DRAWINGS

FIG. 1 is a diagram of a screen print of choosing strong and weak or growth area competencies;

FIG. 2 is a diagram of a screen print of choosing items that contribute toward a strength;

FIG. 3 is a diagram of a screen print of choosing items that contribute toward a weakness or growth area;

FIGS. 4A and 4B are a strengths summary report;

FIGS. 5A and 5B are a weakness or growth area summary report; and

FIG. 6 is a comparison matrix report.

### DETAILED DESCRIPTION OF THE PREFERRED EMBODIMENTS

The concept and methodology of the present invention are specifically designed to be easily implemented via a variety of technologies, including, but not limited to, paper-based surveys, scanable forms, computer- and web-based, and interactive voice response systems.

The present invention incorporates some of the features of traditional multirater surveys, for example, Subjects, Anonymity, Self-Evaluation and Anonymous Comments described under items 1, 2, 3 and 5 under section “Related Art”. However, the differences are discussed below:

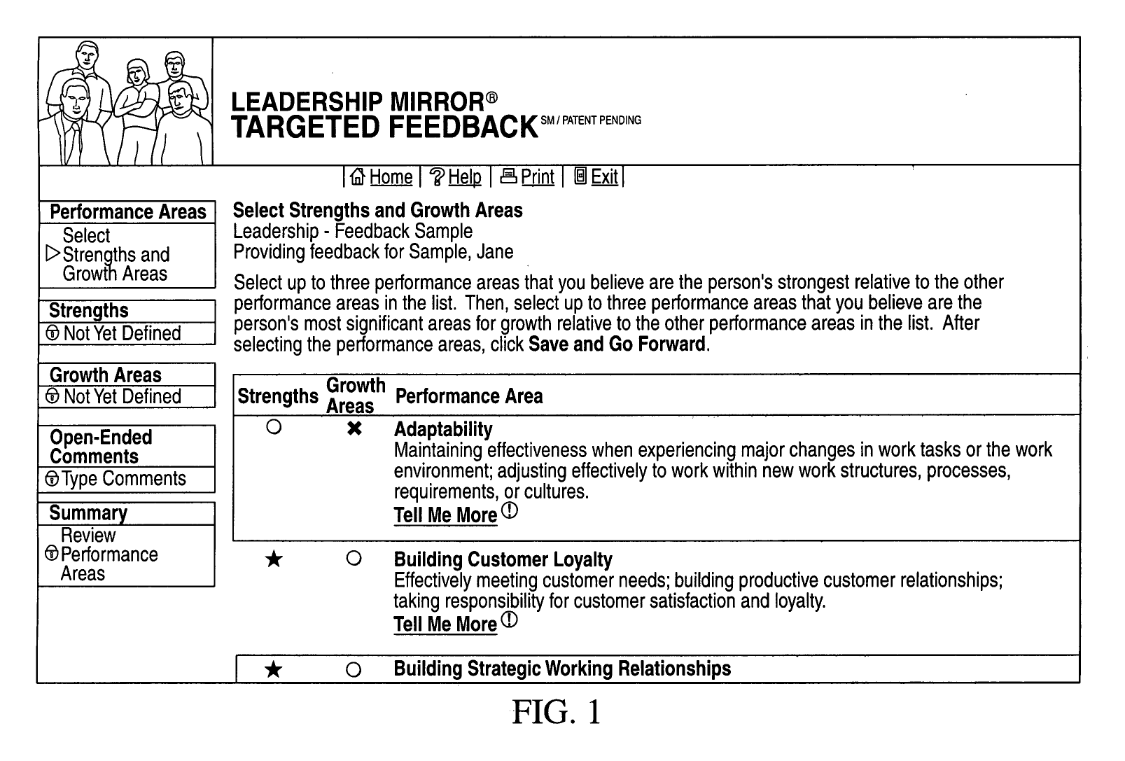

When evaluating a subject, respondents select one to three competencies that they believe are that person's strongest, relative to other competencies on the list. They also are directed to select between one and three competencies in which they feel the subject requires improvement. The task is a selection activity. There are no rating scales involved. Regardless of the number of competencies in the survey, respondents never need to work in depth with more than six. See FIG. 1 for an example of the present invention process in a web-based interface.

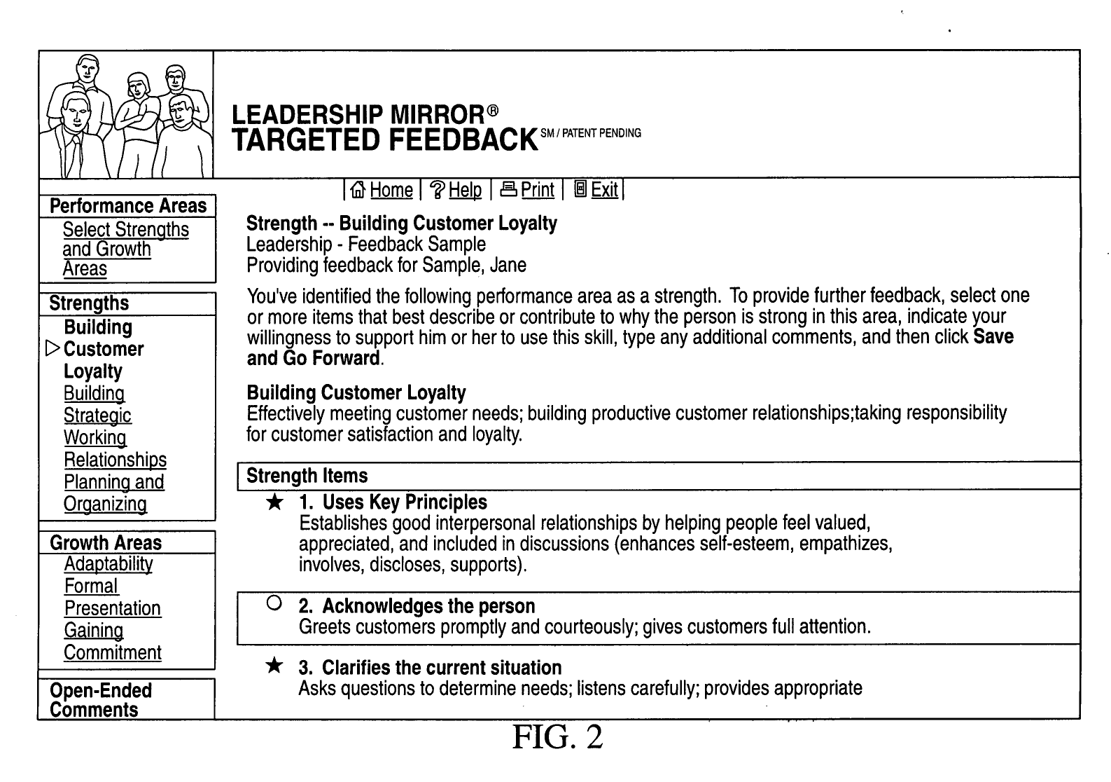

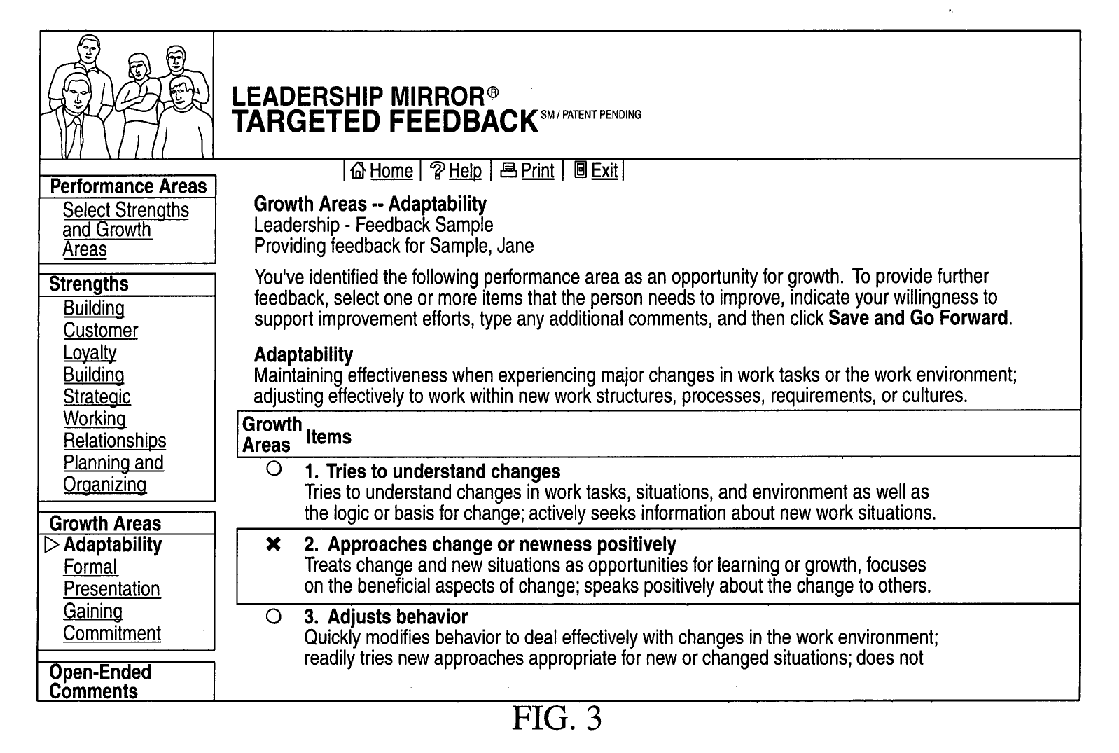

For each of the competencies selected, respondents optionally choose from a short list of key behaviors or items they feel most contribute to the subject's strengths or weaknesses. Again, this is just a selection task with no use of a numeric scale. See FIGS. 2 and 3 for examples of the present invention process in a web-based interface.

In addition, respondents also are asked to indicate their willingness (as a Yes/No response) to support the subject in development efforts. This may also be done by providing the respondent with an open-ended comment box in which to record the respondent's ideas for the subject's development.

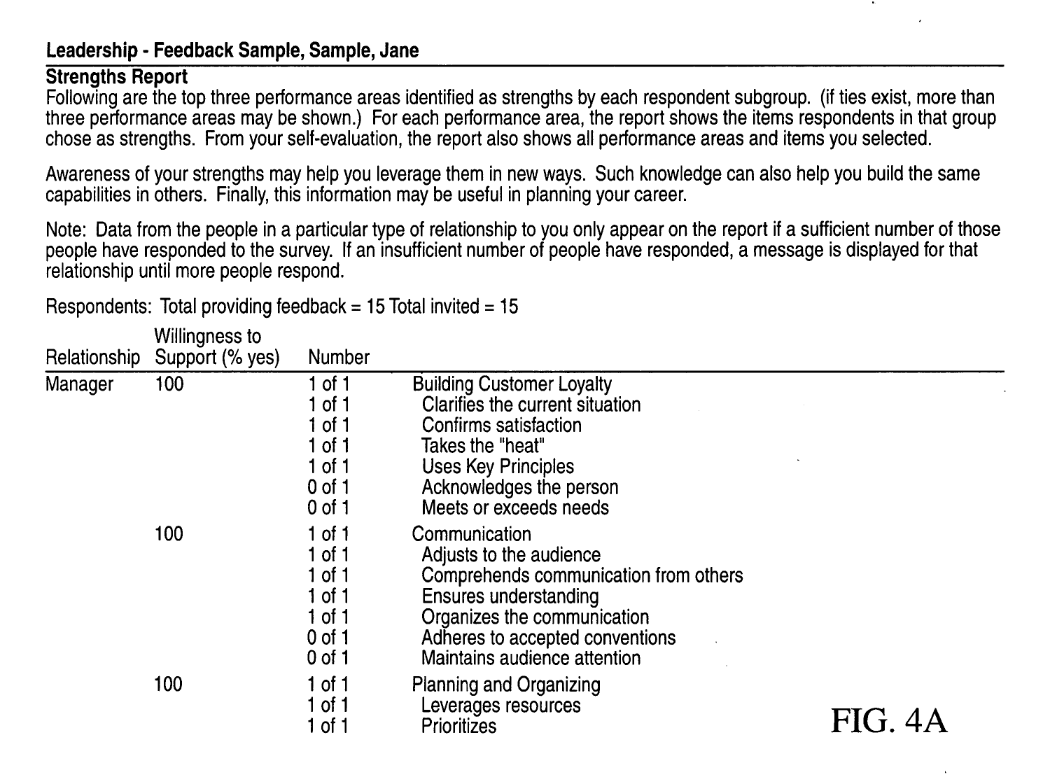

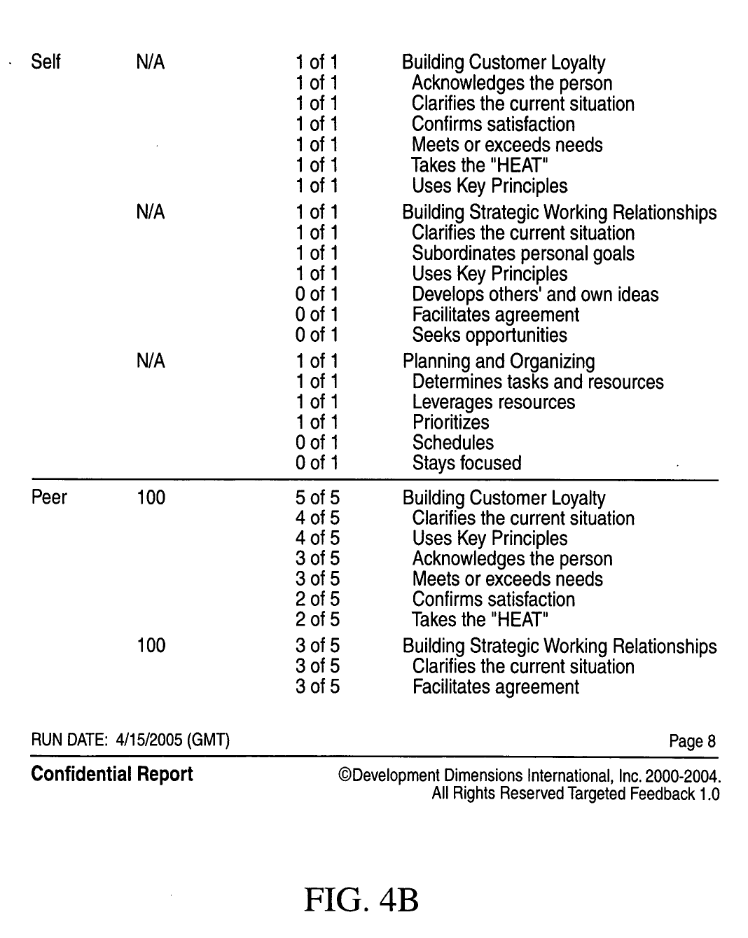

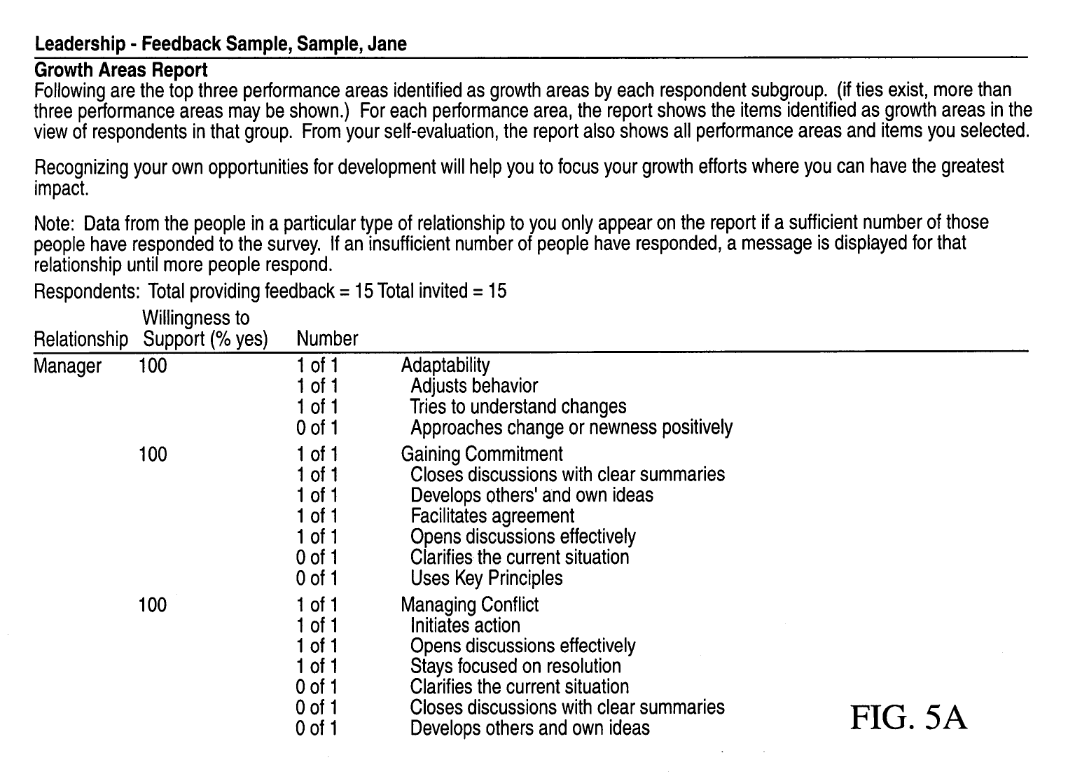

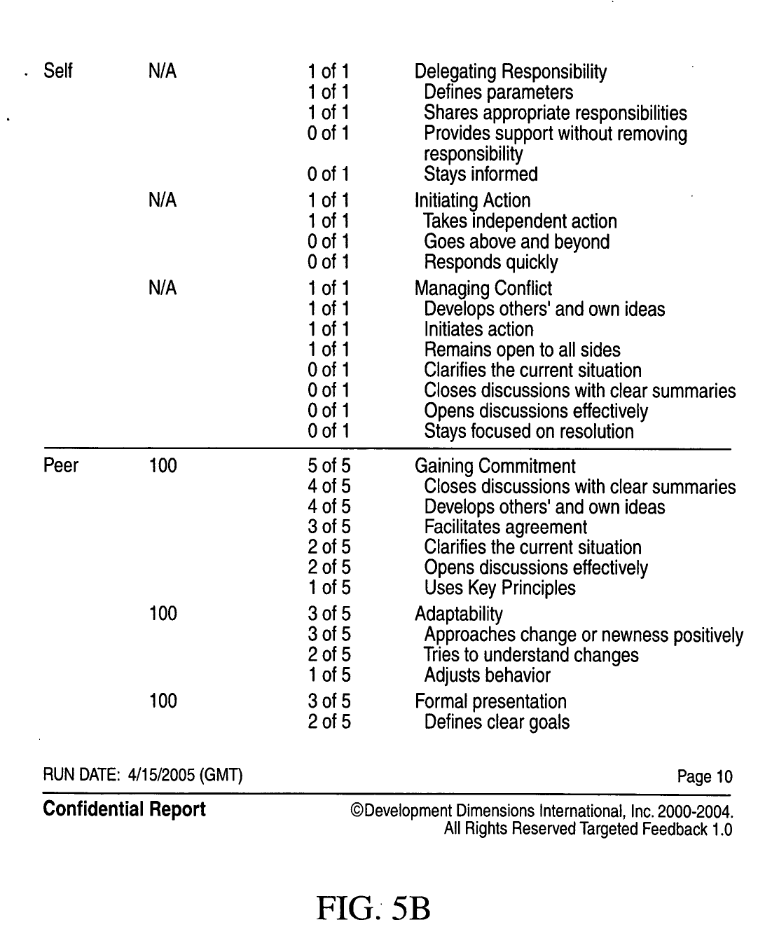

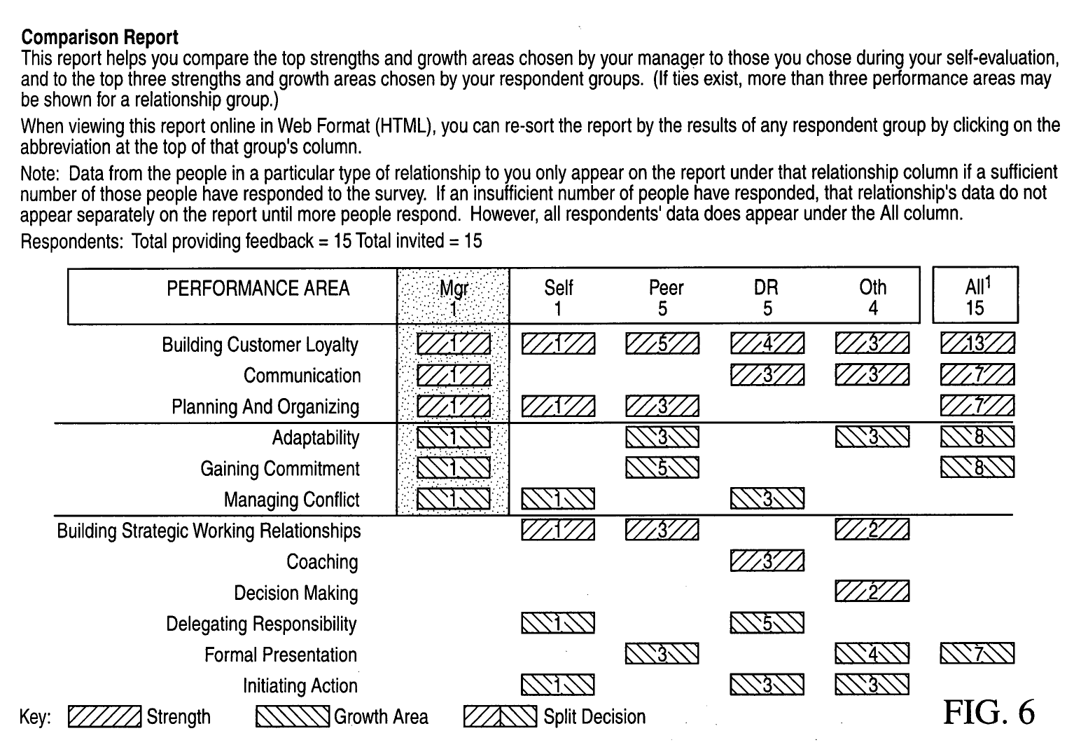

The feedback reports of the present invention show a given subject which three competencies were most frequently chosen as strengths and which three were most frequently chosen as areas for improvement, by relationship type. That is, on the report (screen or printout), the subject sees the choices (at both the competency and item level) made by the manager, his/her own choices, and those made by peers, direct reports, customers, and any other relationship groups surveyed. See FIGS. 4A-5B. In the comparison matrix report (FIG. 6), the subject can see at a glance the agreement or variance among the respondent groups, organized by the manager's choices. When the report is viewed in a Web browser, the subject may elect to organize the matrix by a different respondent group's choices. There are no rating scale averages related to the competencies or items selected in any of the reports. If there were any open-ended feedback comments provided by the respondents related to a given competency, those comments are sorted and displayed as comments associated with the competency when chosen as a strength, and separately those associated with the competency when chosen as a weakness.

In one computer based method contemplated by the present invention, an on-line evaluation program is accessed via a communications network initiated with e-mail invitations to subjects and respondents, containing embedded hyperlinks to the evaluation program. The evaluation program allows the evaluator to select the competencies that the evaluator believes to be the weakest and strongest and to choose a behavior that is believed to contribute to each selected competency. In one computer based system contemplated by the present invention, a computer server is utilized via an electronic-mail communications network. Executable software stored on the server and executable on demand is utilized to run an evaluation program that allows the evaluator to select the competencies that the evaluator believes to be the weakest and strongest and to choose a behavior that is believed to contribute to each selected competency.

Although the invention has been described in detail for the purpose of illustration, it is to be understood that the invention is not limited to the disclosed embodiments and is intended to cover modifications and similar arrangements. For example, all steps may be performed by manual labor in a paper-based implementation; conversely, all steps may be performed by the technological arts using computer hardware and software in a nontrivial manner. The present invention may be implemented through a database structure on a series of networked computers and/or servers. The present invention may utilize an on-line web-based environment utilizing a suitable database, hardware, software, network, and/or electronic mail platforms, including but not limited to intranets, internets, or other web-based environment available on a single computer, a network of computers, or a local server, or an intranet or internet on the world-wide-web.

What is claimed is:

1. A computer-implemented method for on-line subject evaluation comprising:
accessing an on-line evaluation program via a communications network;
selecting at least one competency on-line that is believed to be the subject's strongest;
selecting at least one competency on-line that is believed to be the subject's weakest; and
providing the results of the selected competencies.

2. The method of claim 1, further comprising choosing at least one behavior on-line that is believed to contribute to each selected competency.

3. The method of claim 1, further comprising indicating a willingness to support the subject in developmental efforts.

4. The method of claim 1, further comprising generating an-on-line report showing selected competencies.

5. A computer system for providing evaluation of a subject, the system comprising:
a computer server accessible via a communications network; and
executable software stored on the server and executable on demand, the software operative with the server to cause:
access to an on-line subject evaluation program;
completion of an on-line evaluation comprising:
selection of at least one competency on-line that is believed to be the subject's strongest; and
selection of at least one competency on-line that is believed to be the subject's weakest;
aggregation of the evaluation results; and
formulation of an evaluation report.

6. The computer system of claim 5, wherein the software further initiates the choosing of at least one behavior on-line that is believed to contribute to each selected competency.

7. A method of evaluating a subject comprising:
selecting at least one competency that is believed to be the subject's strongest;
selecting at least one competency that is believed to be the subject's weakest; and
providing the results of the selected competencies.

8. The method of claim 7, further comprising choosing at least one behavior that is believed to contribute to each selected competency.

9. The method of claim 7, further comprising indicating a willingness to support the subject in developmental efforts.

10. The method of claim 7, further comprising generating a report showing selected competencies.

11. The method of claim 7, wherein the method is performed utilizing a computer network.

12. The method of claim 7, wherein the method is performed utilizing a web-based interface.
